(19) United States
(12) Patent Application Publication
(10) Pub. No.: US 2010/0001670 A1
(43) Pub. Date: Jan. 7, 2010

(54) SINGLE-CHIP BRUSHLESS MOTOR CONTROLLER

(75) Inventor: Christopher A. Scalese, Tucson, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.,, Morristown, NJ (US)

(21) Appl. No.: 12/167,964

(22) Filed: Jul. 3, 2008

(51) Int. Cl. H02P 6/00

(52) U.S. Cl. 318/400.09

(57) ABSTRACT

A brushless motor control is provided that includes an application processor and a motor controller chip. The application processor includes a serial interface and is configured to supply, via the serial interface, motor control commands, and to receive, via the serial interface, data representative of motor operational state. The motor controller chip is in operable communication with the application processor, and has formed thereon a motor controller serial interface, a first control, and a second control, which cooperate together to controllably energize a brushless motor.

### TECHNICAL FIELD

The present invention generally relates to brushless motor control and, more particularly, to a single-chip brushless motor controller.

### BACKGROUND

Increasingly, various industries are moving toward the use of electric motors as control devices. For example, the aircraft industry is increasingly relying on the use of electric motors to controllably move valves, flight control surfaces, brakes, and various other aircraft components. In a typical implementation, a motor controller may receive a command from an external system or device to move a particular component (or components) to a particular position. The motor controller will in turn controllably energize an electric motor to move the component to the commanded position.

In many instances, the type of motor that is used in the above-described implementations is a brushless motor. As is generally known, brushless motor control relies upon position and current feedback to properly regulate and commutate the motor to generate torque. The position, current, and commutation controls implemented in brushless motor controllers may be software-intensive, and may vary from end-use component to end-use component. Regulatory requirements associated with software verification and validation can result in relatively expensive development costs and relatively expensive recurring costs.

What is needed is a brushless motor controller implementation that does not exhibit a recurring cost associated with different end-use components. In other words, once the develop costs associated with the brushless controller (including software verification and validation) have been incurred, what is needed is for there to be no (or little) recurring costs to associate the brushless motor controller with various end-use components. The present invention addresses at least this need.

### BRIEF SUMMARY

In one embodiment, and by way of example only, a brushless motor control system includes a brushless motor, an application processor, and a motor controller chip. The brushless motor is configured to be controllably energized. The application processor includes a serial interface and is configured to supply, via the serial interface, motor control commands, and to receive, via the serial interface, data representative of motor operational state. The motor controller chip is in operable communication with the application processor, and has formed thereon a motor controller serial interface, a first control, and a second control. The motor controller serial interface is in operable communication with the application processor serial interface to receive the motor control commands therefrom and to supply the data representative of motor operational state data thereto. The first control is coupled to receive the motor commands from the motor controller serial interface, and to further receive motor state data. The first control is operable, in response to the motor control commands and the motor state data, to supply current commands. The second control is coupled to receive the current commands and motor current data and is operable, in response thereto, to controllably energize the brushless motor.

In another exemplary embodiment, a brushless motor control circuit includes an application processor, and a motor controller chip. The application processor includes a serial interface and is configured to supply, via the serial interface, motor control commands, and to receive, via the serial interface, data representative of motor operational state. The motor controller chip is in operable communication with the application processor, and has formed thereon a motor controller serial interface, a first control, and a second control. The motor controller serial interface is in operable communication with the application processor serial interface to receive the motor control commands therefrom and to supply the data representative of motor operational state data thereto. The first control is coupled to receive the motor commands from the motor controller serial interface, and to further receive motor state data. The first control is operable, in response to the motor control commands and the motor state data, to supply current commands. The second control is coupled to receive the current commands and the motor current data and is operable, in response thereto, to supply control signals useful for controllably energizing a brushless motor.

In yet a further exemplary embodiment, a brushless motor control circuit includes an application processor and a motor controller chip. The application processor includes a serial interface and is configured to supply, via the serial interface, motor control commands and operational mode program data representative of a desired operational mode of the brushless motor. The application processor is further configured to receive, via the serial interface, data representative of motor operational state. The motor controller chip is in operable communication with the application processor and has formed thereon a motor controller serial interface, a first control, and a second control. The motor controller serial interface is in operable communication with the application processor serial interface to receive the motor control commands and the operational mode program data therefrom, and to supply the data representative of motor operational state data thereto. The first control is coupled to receive the motor commands from the motor controller serial interface, and to further receive motor state data. The first control is operable, in response to the motor control commands and the motor state data, to supply current commands. The second control includes a motor current control and a motor commutation control. The second control is coupled to receive the current commands and the motor current data and is operable, in response thereto, to supply control signals useful for controllably energizing a brushless motor. The motor controller chip is further configured, in response to the operational mode program data, to cause the first control to selectively implement one of a position control, a speed control, or both.

Furthermore, other desirable features and characteristics of the motor controller chip, and devices and systems that include the motor controller chip, will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of an exemplary brushless motor control system; and

FIG. 2 depicts a functional block diagram of an exemplary motor controller chip that may be used to implement the system of FIG. 1.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

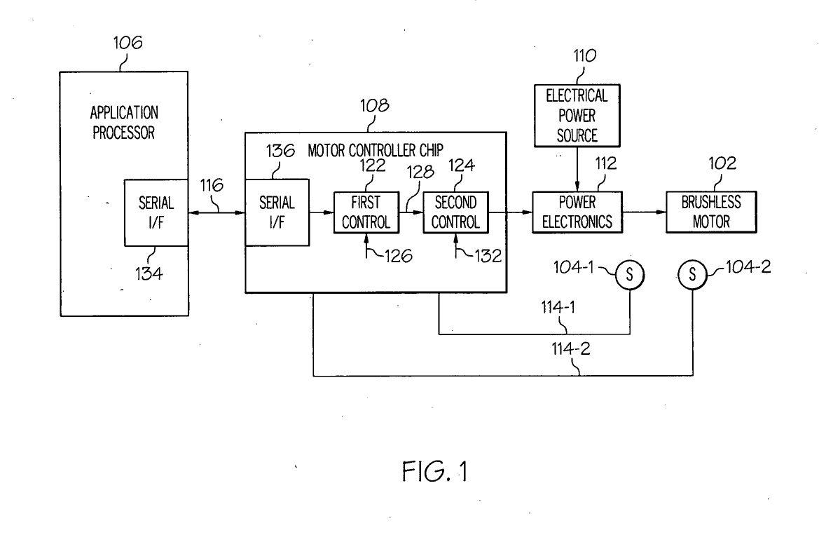

Turning now to FIG. 1, a functional block diagram of a brushless motor control system 100 is depicted, and includes a brushless motor 102, a plurality of sensors 104 (e.g., 104-1, 104-2), an application processor 106, and a motor controller chip 108. The brushless motor 102 is controllably energized from an electrical power source 110, via suitable power electronics 1 12. More specifically, the power electronics 112, in response to control signals supplied from the motor controller chip 108, controllably energize the windings of the brushless motor 102 and cause it to rotate. The rotation of the brushless motor 102 may drive one or more non-illustrate loads. In the depicted embodiment the power electronics 112 is shown being implemented as part of the brushless motor 102. It will be appreciated, however, that this is merely exemplary, and that the power electronics 112 could be implemented and disposed separate and distinct from the brushless motor 102.

The sensors 104 are configured to sense various parameters and supply feedback signals 114 (e.g., 114-1, 114-2) representative of the sensed parameters to the motor controller chip 108. These sensed parameters may vary, but in the depicted embodiment, the parameters include motor current and motor position/speed (e.g., motor rotor rotational position/speed). Various numbers and types of sensors 104 may be used to sense these parameters and supply the feedback signals representative thereof to the motor controller chip 108. Suitable sensors 104-1 that may be used to sense motor current, and supply a motor current feedback signal 114-1, include sense resistors or linear output Hall effect sensors. Suitable sensors 104 that may be used to sense motor rotor position/speed, and supply motor position/speed feedback, include resolvers, discrete Hall effect sensors, and encoders. Preferably, the same sensors that are used for motor commutation are also used to supply the position/speed feedback signal 114-2 to the motor controller chip 108.

The application processor 106 is configured to compute target position and/or speeds for the brushless motor 102, and to supply motor commands 116 representative thereof to the motor controller chip 108. The application processor 106 additionally receives, from the motor controller chip 108, data representative of the operational state of both the brushless motor 102 and the motor controller chip 108. These data may vary, but some non-limiting examples of operational state data include data representative of motor speed, motor current, and motor position, as well as various motor controller chip built-in-test data, just to name a few. The application processor 106 is additionally configured to supply, to the motor controller chip 108, operational mode program data and motor control parameter data. The operational mode program data are data representative of the desired operational mode of the brushless motor 102. That is, whether the position of the brushless motor 102, the speed of the brushless motor 102, or both, will be controlled. In other words, whether the motor controller chip 108 will implement position control and/or speed control. The motor control parameter data are data representative of the particular control parameters associated with the commanded operational state. For example, the particular gains to be used to implement the position and/or speed control in the motor controller chip 108.

The motor controller chip 108 is coupled to receive the motor commands 116 from the application processor 106 and the feedback signals 114 from the sensors 104. The motor controller chip 108, in response to the motor commands 116 and the feedback signals 114, controllably energizes the brushless motor 102 from the electrical power source 110. The brushless motor 102, as noted above, may be used to drive one or more loads to the commanded position and/or at a commanded speed. In the depicted embodiment, the motor controller chip 108 implements this functionality via a first control 122 and a second control 124. The first control 122 is configured to selectively implement position control and/or speed control, and the second control 124 is preferably configured to implement current control. As was alluded to above, the operational mode program data that the application processor 106 supplies to the motor controller chip 108 determines the particular control scheme that the first control 122 implements.

The first control 122 is coupled to receive the motor commands 116 from the application processor 106 and is additionally coupled to receive motor state data 126. The first control 122 is operable, in response to these data, to supply current commands 128 to the second control 124. It will be appreciated that the motor state data are data representative of motor position and/or speed, depending upon whether the first control 122 is configured to implement position control and/or speed control, and are derived from the position/speed sensor 104-2. The second control 124 is coupled to receive the current commands 128 and motor current data 132 and, implementing a suitable commutation control scheme, is operable to supply suitable control signals to, for example, the power electronics 112. The power electronics 112 are responsive to these control signals to controllably energize the brushless motor 102 from the electric power source 110.

It will be appreciated that the first control 122 may implement any one of numerous position and/or speed controls, now known or developed in the future, and that the second control 124 may be implemented using any one of numerous current controls, now known or developed in the future. Detailed descriptions of the position, speed, and current controls are not needed to fully describe or enable the invention, and as such will not be further described. It will additionally be appreciated that the second control 124 may implement any one of numerous suitable commutation control schemes, both trapezoidal and non-trapezoidal, now known or developed in the future. However, as will be described in more detail further below, in a particular preferred embodiment the second control 124 implements field-oriented control (FOC).

Before proceeding further, it is noted that the application processor 106 and the motor controller chip 108 preferably communicate with each other via synchronous serial communication. As such, and as FIG. 1 depicts, the application processor 106 and the motor controller chip 108 both preferably include a serial interface. As used herein, the serial interface on the application processor 106 is referred to as the application processor serial interface 134, and the serial interface on the motor controller chip 108 is referred to as the motor controller serial interface 136. It will be appreciated that the particular serial interface used on the application processor 106 and motor controller chip 108 may vary. Some non-limiting examples of suitable serial interfaces that may be used include a suitable controller area network (CAN) interface, a serial peripheral interface (SPI), an inter-integrated circuit (I²C) interface, or a serial communication interface (SCI).

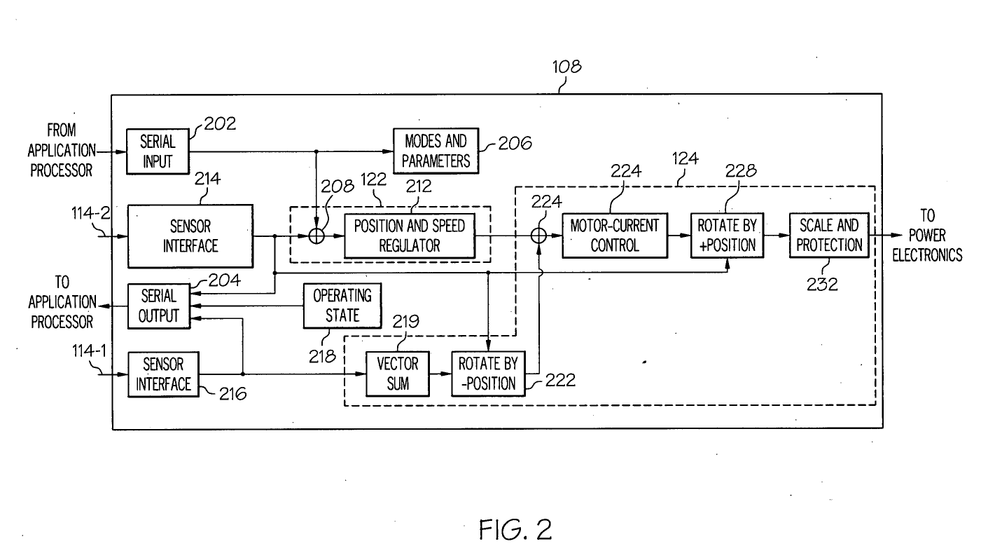

The motor controller chip 108 is disposed on a single integrated circuit package, such as a digital signal processor (DSP), and as noted above, is operated under the control of the application processor 106. A more detailed functional block diagram of the motor controller chip 108, illustrating in slight more detail the functions it implements, is depicted in FIG. 2, and with reference thereto will now be described.

As noted above, the application processor 106 and the motor controller chip 108 both preferably include a serial interface. Thus, a serial interface input 202 and a serial interface output 204, which at least partially comprise the motor controller serial interface 136, are depicted in FIG. 2. The serial interface input 202 is receives the operational mode program data, the motor control parameter data, and the motor commands from the application processor 106. The operational mode program data and the motor control parameter data are appropriately stored 206, and are retrieved and used, as needed, to implement the operational mode corresponding to these data.

The motor commands are supplied to the first control 122, which includes a first comparator function 208 and a position/speed regulator 212. The first comparator function 208 receives the motor commands and also receives data representative of sensed motor position/speed. These latter data are supplied to the first comparator function 208 from a first sensor interface 214. The first sensor interface 214 receives the analog position/speed feedback signal 114-2 from the position/speed sensor 104-2, conducts appropriate analog-to-digital (A/D) conversion, and any other suitable demodulation/decoding thereof, and supplies, as appropriate, data representative of sensed motor position, speed, and/or acceleration to the first comparator function 208. The first sensor interface 214 may additionally be configured to supply appropriate sensor excitation to the position/speed sensor 104-2, depending upon the type of position/speed sensor 104-2 that is used. In any case, the first comparator function 208 compares the motor commands and the sensed motor position/speed, and supplies position/speed error data to the position/speed regulator 212. The position/speed regulator 212, based on the error signal, supplies the current commands 128 to the second control 124.

In addition to being supplied to the first control 122, the data representative of sensed motor position, speed, and/or acceleration are also supplied to the serial interface output 204 for transmission to the application processor 106. As FIG. 2 further depicts, the serial interface output 204 additionally receives data from a second sensor interface 216 and operating state data 218. The data from the second sensor interface 216 are data representative of motor current, and the operating state data 218 are, for example, the above-mentioned built-in-test data. In this manner, as was also previously noted, the application processor 106 is able to monitor the operational state of both the brushless motor 102 and motor controller chip 108.

The just-mentioned second sensor interface 216 is configured to receive analog current feedback signals 114-1 from the current sensors 104-1, conduct appropriate A/D conversion, and supply the data representative thereof. These data, in addition to being supplied to the serial interface output 204, are also supplied to the second control 124. It may be seen that the second control 124, at least in the depicted embodiment, includes a vector sum function 219, a first rotate function 222, a second comparator function 224, a motor current control 226, a second rotate function 228, and a scale and projection function 232.

The vector sum function 219 receives the data representative of, and determines the vector sum of, the sensed motor winding currents. The vector sum of the motor currents, as is generally known, may be expressed as a complex number, having a real component and an imaginary component. The vector sum of the motor currents is supplied to a first rotate function 222, which also receives data representative of sensed motor position, and which functions to align the real portion of the vector sum with the rotor of the brushless motor 102. The first rotate function 222 supplies data representative of the aligned current to the second comparator function 224.

The second comparator function 224 receives the current commands supplied from the position/speed regulator 212 and the aligned current data supplied from the first rotate function 222. The second comparator function 224 compares the current commands 128 and the aligned current data, and supplies current error data to the motor current control 226. The motor current control 226, in response to the current error data, supplies motor voltage commands to the second rotate function 228. The second rotate function 228 receives the motor voltage commands and data representative of sensed motor position and, in response, rotates the commanded voltage so that the real portion is properly aligned. For example, so that the real portion is aligned with the stator winding disposed at the zero-degree position. The second rotate function 228 supplies data representative of the aligned voltage command to the scale and projection function 232, which projects and scales the aligned voltage command to the winding axes, which are disposed 120-degrees apart. In the depicted embodiment, these projections are representative of voltage duty-cycles supplied to the power electronics 112, which in turn controllably energize the brushless motor 102 from the electrical power source 110.

The motor controller chip 108 described herein is a single, preprogrammed integrated circuit device that, for certain end-uses, need only be certified once. Preferably, the motor controller chip 108 is configured to receive and store numerous and varied parameters. In this manner, the control code may be certified over a wide range of parameter values, while allowing the specific parameter values to be selected to meet desired functional, design, and/or performance requirements. The motor controller chip 108 furthermore has a relatively small space-envelope, exhibits relatively low recurring costs, and may be interfaced with numerous and varied systems and devices.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A brushless motor control system, comprising:
a brushless motor configured to be controllably energized;
an application processor having a serial interface and configured to supply, via the serial interface, motor control commands, and to receive, via the serial interface, data representative of motor operational state; and
a motor controller chip in operable communication with the application processor, the motor controller chip having formed thereon:
a motor controller serial interface in operable communication with the application processor serial interface to receive the motor control commands therefrom and to supply the data representative of motor operational state data thereto,
a first control adapted to receive the motor commands from the motor controller serial interface, and to further receive motor state data, the first control operable, in response to the motor control commands and the motor state data, to supply current commands,
a second control coupled to receive the current commands and motor current data and operable, in response thereto, to controllably energize the brushless motor.

2. The system of claim 1, wherein:
the application processor is further configured to supply, via the application processor serial interface, operational mode program data representative of a desired operational mode of the brushless motor;
the motor controller serial interface is operable to receive the operational mode program data from the application processor serial interface; and
the motor controller chip is further configured, in response to the operational mode program data, to cause the first control to implement one of a position control or a speed control.

3. The system of claim 2, wherein:
the application processor is further configured to supply, via the application processor serial interface, motor control parameter data;
the motor controller serial interface is operable to receive the motor control parameter data from the application processor serial interface; and
the motor controller is further configured, in response to the

4. The system of claim 1, wherein:
the motor controller chip is further configured to implement a plurality of built-in tests and supply built-in-test data representative of built-in test results; and
the operational state data include the built-in-test data.

5. The system of claim 1, wherein:
the motor controller chip further has formed thereon a first sensor interface; and
the first sensor interface includes an analog-to-digital converter (A/D) coupled to receive analog position signals and supply digital position data representative thereof to the first control.

6. The system of claim 1, wherein:
the motor controller chip further has formed thereon a second sensor interface; and
the second sensor interface includes an analog-to-digital converter (A/D) coupled to receive analog motor current signals and supply digital current data representative thereof to the second control.

7. The system of claim 1, wherein the second control includes a motor current control and a commutation control.

8. The system of claim 7, wherein the commutation control implements field oriented control.

9. A brushless motor control circuit, comprising:
an application processor having a serial interface and configured to supply, via the serial interface, motor control commands, and to receive, via the serial interface, data representative of motor operational state; and
a motor controller chip in operable communication with the application processor, the motor controller chip having formed thereon:
a motor controller serial interface in operable communication with the application processor serial interface to receive the motor control commands therefrom and to supply the data representative of motor operational state data thereto,
a first control adapted to receive the motor commands from the motor controller serial interface, and to further receive motor state data, the first control operable, in response to the motor control commands and the motor state data, to supply current commands,
a second control coupled to receive the current commands and motor current data and operable, in response thereto, to supply control signals useful for controllably energizing a brushless motor.

10. The control circuit of claim 9, wherein:
the application processor is further configured to supply, via the application processor serial interface, operational mode program data representative of a desired operational mode of the brushless motor;
the motor controller serial interface is operable to receive the operational mode program data from the application processor serial interface; and
the motor controller chip is further configured, in response to the operational mode program data, to cause the first control to selectively implement one of a position control, a speed control, or both.

11. The control circuit of claim 10, wherein:
the application processor is further configured to supply, via the application processor serial interface, motor control parameter data;
the motor controller serial interface is operable to receive the motor control parameter data from the application processor serial interface; and
the motor controller is further configured, in response to the

12. The control circuit of claim 9, wherein:
the motor controller chip is further configured to implement a plurality of built-in tests and supply built-in-test data representative of built-in test results; and
the operational state data include the built-in-test data.

13. The control circuit of claim 9, wherein:
the motor controller chip further has formed thereon a first sensor interface; and
the first sensor interface includes an analog-to-digital converter (A/D) coupled to receive analog position signals and supply digital position data representative thereof to the first control.

14. The control circuit of claim 9, wherein:
the motor controller chip further has formed thereon a second sensor interface; and
the second sensor interface includes an analog-to-digital converter (A/D) coupled to receive analog motor current signals and supply the motor current data to the second control.

15. The control circuit of claim 9, wherein the second control includes a motor current control and a commutation control.

16. The control circuit of claim 15, wherein the commutation control implements field oriented control.

17. A brushless motor control circuit, comprising:
an application processor having a serial interface and configured to supply, via the serial interface, motor control commands and operational mode program data representative of a desired operational mode of the brushless motor, the application processor further configured to receive, via the serial interface, data representative of motor operational state; and
a motor controller chip in operable communication with the application processor, the motor controller chip having formed thereon:
a motor controller serial interface in operable communication with the application processor serial interface to receive the motor control commands the operational mode program data therefrom, and to supply the data representative of motor operational state data thereto,
a first control adapted to receive the motor commands from the motor controller serial interface, and to further receive motor state data, the first control operable, in response to the motor control commands and the motor state data, to supply current commands,
a second control including a motor current control and a motor commutation control, the second control coupled to receive the current commands and motor current data and operable, in response thereto, to supply control signals useful for controllably energizing a brushless motor,
wherein the motor controller chip is configured, in response to the operational mode program data, to cause the first control to selectively implement one of a position control, a speed control, or both.
